(19) United States
(12) Patent Application Publication
(10) Pub. No.: US 2009/0132580 A1
(43) Pub. Date: May 21, 2009

(54) Systems and Methods for Creating and Viewing Clinical Protocols

(75) Inventors: Alan Ferris James, Salt Lake City, UT (US); William Murray Stoval, III, Draper, UT (US); Vijayanand Tirumalai N.C., Draper, UT (US)

Correspondence Address: MCANDREWS HELD & MALLOY, LTD, 500 WEST MADISON STREET, SUITE 3400, CHICAGO, IL, 60661, US

(73) Assignee: GENERAL ELECTRIC COMPANY, Schenectady, NY (US)

(21) Appl. No.: 11/944,011

(22) Filed: Nov. 21, 2007

(51) Int. Cl. G06F 17/30

(52) U.S. Cl. 707/102; 707/E17.001

(57) ABSTRACT

Certain embodiments of the present invention provide a clinical workflow system including a user interface adapted to present a visualization of a workflow to a user. The workflow represents a clinical protocol including a plurality of tasks. The user interface is adapted to generate a state machine for the workflow based on the clinical protocol by converting a sequential model of the clinical protocol into a plurality of states. Each state is associated with a task in the clinical protocol. At least one state in the state machine is connected with a non-sequential state.

### BACKGROUND OF THE INVENTION

The present invention generally relates to clinical protocols. More particularly, the present invention relates to systems and methods for creating and viewing clinical protocols.

Healthcare has become increasingly centered around electronic data and records management. Healthcare environments, such as hospitals or clinics, include information systems, such as healthcare information systems (HIS), radiology information systems (RIS), clinical information systems (CIS), cardiovascular information systems (CVIS), picture archiving and communication systems (PACS), library information systems (LIS), and electronic medical records (EMR). Information stored may include patient medical histories, imaging data, test results, diagnosis information, management information, and/or scheduling information, for example. The information for a particular information system may be centrally stored or divided at a plurality of locations. Healthcare practitioners may desire to access patient information or other information at various points in a healthcare workflow.

Current software applications typically support clinical users performing a wide range of workflows and interacting with significant volumes of clinical information. Such systems may incorporate features such as, to-do lists, clinical decision support, and/or workflow engines to help automate some of the work that needs to be accomplished during the execution of complex workflows. In a conventional clinical application, for example, a single workflow, such as discharging the patient from the emergency room, might involve the user executing multiple tasks. For example, Care Process Plans, such as a Pneumonia Care Process Plan or Diabetes CPM Screening and Diagnosis, are often represented as flow charts with steps the involve multiple people and departments and often are executed over a multiple day time span. These tasks may require the user to navigate to several different parts of the application in order to perform each step of that workflow. For example, data must be entered on multiple forms, laboratory results must be reviewed, and decision support results must be accessed.

Navigating through such complex software systems can be challenging if the user isn't sure where to go within the application to perform the specific task. For example, the correct form to enter vital signs may be in one location, the laboratory results in another, the prescription ordering application in another.

Such navigation can also be tedious, as the system may require the user to perform several gestures, such as mouse clicks, to get the application properly configured to perform the task.

In addition, for many clinical workflows, there may be more than one clinical user performing tasks that relate to the specific workflow. For example, a nurse manages vital signs, a physician orders laboratory tests, and a radiologist reads the x-ray. It can be difficult for multiple users to visualize which tasks have been completed already and which ones remain. Thus, the users may be unable to effectively coordinate their efforts.

### BRIEF SUMMARY OF THE INVENTION

Certain embodiments of the present invention provide a clinical workflow system including a user interface adapted to present a visualization of a workflow to a user. The workflow represents a clinical protocol including a plurality of tasks. The user interface is adapted to generate a state machine for the workflow based on the clinical protocol by converting a sequential model of the clinical protocol into a plurality of states. Each state is associated with a task in the clinical protocol. At least one state in the state machine is connected with a non-sequential state.

Certain embodiments of the present invention provide a method for performing a clinical protocol including generating a workflow including a state machine, displaying a visualization of the workflow to a user with a user interface, and receiving input from the user relating to a current state of the workflow. The workflow represents a clinical protocol including a plurality of tasks. The state machine is generated based on the clinical protocol by converting a sequential model of the clinical protocol into a plurality of states. Each state is associated with a task in the clinical protocol. At least one state in the state machine is connected with a non-sequential state.

Certain embodiments of the present invention provide a computer-readable medium including a set of instructions for execution on a computer, the set of instructions including a workflow generation routine configured to generate a workflow including a state machine, a workflow display routine configure to display a visualization of the workflow to a user, and an input routine configure to receive input from the user relating to a current state of the workflow. The workflow represents a clinical protocol including a plurality of tasks. The state machine is generated based on the clinical protocol by converting a sequential model of the clinical protocol into a plurality of states. Each state is associated with a task in the clinical protocol. At least one state in the state machine is connected with a non-sequential state.

### BRIEF DESCRIPTION OF SEVERAL VIEWS OF THE DRAWINGS

FIG. 1 illustrates a user interface for a clinical workflow system according to an embodiment of the present invention.

FIG. 2 illustrates a system for creating and/or executing clinical protocols according to an embodiment of the present invention.

FIG. 3 illustrates an enlarged view of the activities component according to an embodiment of the present invention.

FIG. 4 illustrates an enlarged view of the workflow visualization component according to an embodiment of the present invention.

FIG. 5 illustrates an enlarged view of the form component according to an embodiment of the present invention.

FIG. 6 illustrates a user interface for a clinical workflow system according to an embodiment of the present invention.

FIG. 7 illustrates a flow diagram for a method for performing a clinical protocol according to an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

A clinical protocol may be visualized as a flow chart or workflow containing various states, such as a start state, processing states, decision states, and an end state. At each processing state, clinical information may be collected and/or procedures may be performed. At decision states, a clinician may use information previously collected to choose between a set of well-known alternatives to continue the workflow. A characteristic of the clinical workflow, however, is that the clinician is free to skip states, add alternative states, and/or change the order of states in the workflow based on the immediate needs of the patient.

Traditional workflow systems fail to support this process in several ways. First, traditional systems make visualization of both the workflow and the current state of the workflow difficult. That is, current systems do not support visualization of the workflow and the current state. Current systems do not support a link between visualizing a workflow and the applications supporting the workflow. For example, a workflow, such as a pneumonia clinical care plan, may be presented on paper as a flow chart diagram (the usual case) or defined externally through a workflow language while the collection of information is performed independently on a local workstation.

Second, traditional systems do not provide a coupling of the collection of information related to a state in the workflow and the actual definition of the workflow. That is, current systems do not link data processing, such as the collection of information, with the workflow definition itself. For example, the user of the system must manually relate the step in the pneumonia process care plan flow sheet with the correct application and step in the application; the system does not provide this linkage.

Third, traditional systems do not support the mutability of the actual workflow performed. That is, current systems do not support the changes in the workflow such as new states, deleted states, and/or changed order of states due to current circumstances. Clinicians are reluctant to use formal workflows to describe clinical protocols because current systems lock the clinician into a rigid workflow. For example, a complex Clinical Care Plan, once created, drawn, approved, and published, is very difficult to modify since it requires that the entire document be recreated and published.

Fourth, local modification of the protocol is difficult because the workflow may need to be republished or programmed using a workflow language inaccessible to the clinician. That is, users, such as healthcare providers, cannot modify the protocol in current systems because such modification requires operational/programming support.

Certain embodiments of the present invention address these failures by providing a graphical workflow editor that is tightly coupled with the user interface for execution of the workflow. Screen interactions are represented as activities in the workflow. Execution of the workflow presents the appropriate form to the clinician to collect the data. Since forms and other presentation mechanisms are represented as activities in the workflow, conditional logic in the workflow can adapt the user interface to correspond to the current point within the workflow. In certain embodiments, productivity is improved by coupling the design and presentation of a clinical protocol with the presentation of the forms and panels needed to collect and analyze information relating to the protocol. In certain embodiments, the familiar sequential workflow is converted transparently to a state machine to allow user flexibility in executing the workflow. In certain embodiments, a run-time view of a clinical protocol is presented as a clinician uses it showing completed activities, the current activity, upcoming activities, and documentation of each activity as part of a single tool. In certain embodiments, productivity and quality are increased productivity by providing a mechanism to describe, document, and execute best-practice protocols through a standard and extensible tool.

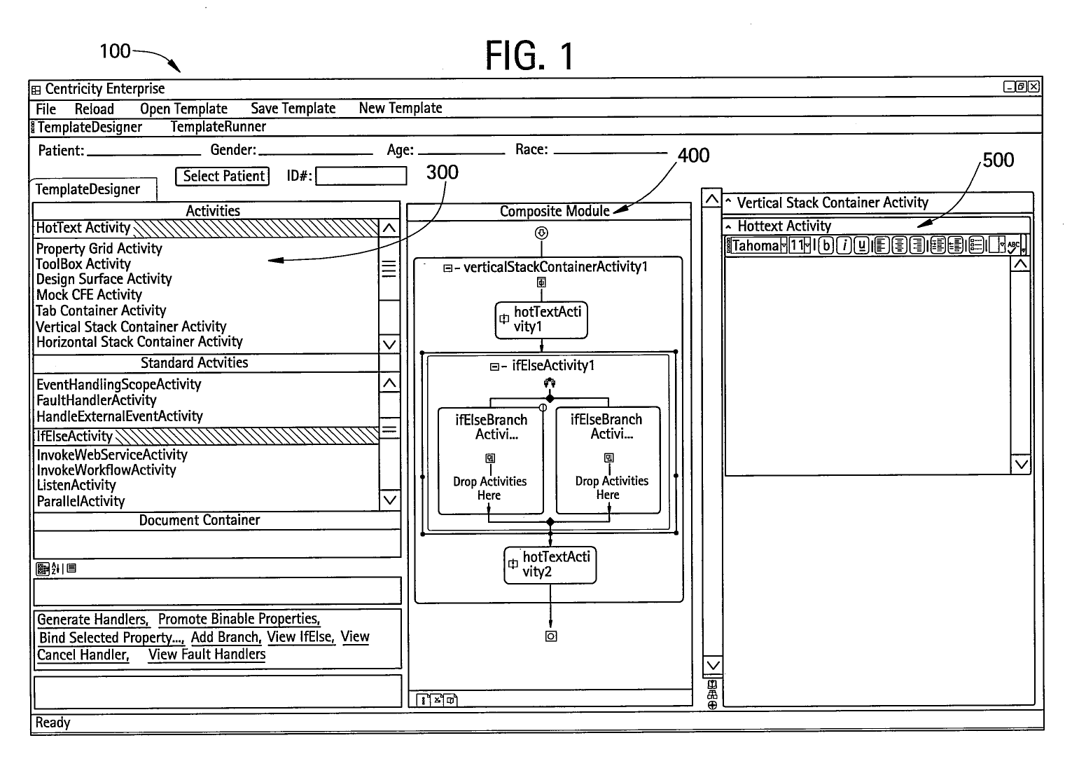

FIG. 1 illustrates a user interface 100 for a clinical workflow system according to an embodiment of the present invention. More particularly, the user interface 100 illustrated in FIG. 1 is for a workflow designer. The user interface 100 includes an activities component 300, a workflow visualization component 400, and a form component 500.

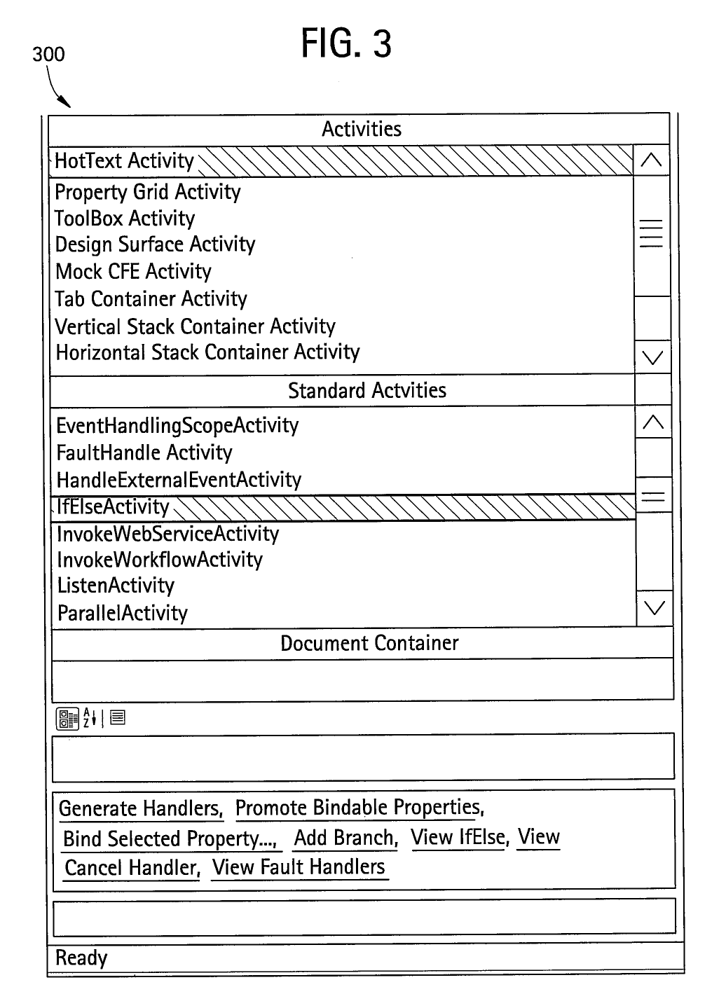

FIG. 3 illustrates an enlarged view of the activities component 300 according to an embodiment of the present invention. The activities component 300 includes the “building blocks” or available steps to be utilized in the creation of a workflow. For example, a “form activity” building block might be linked to a form to collect observations, a “decision support activity” building block might be linked to a call to the clinical decision support system to recommend a course of action inferred from the observations, and a branch in the workflow might be selected based on those results.

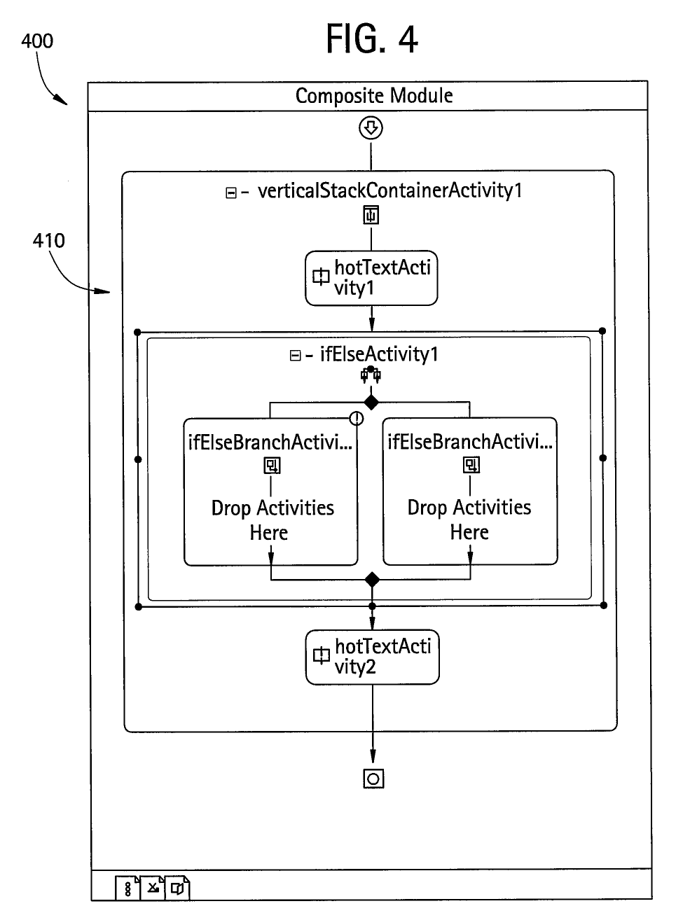

FIG. 4 illustrates an enlarged view of the workflow visualization component 400 according to an embodiment of the present invention. The workflow visualization component 400 is adapted to provide a visual representation of a workflow 410. The visualization of the workflow 410 may be provided to a user such as a healthcare provider, for example. The workflow 410 may be the workflow being built/designed using the interface 100, for example. The workflow 410 represents a clinical workflow having one or more tasks. The workflow 410 includes one or more states, each state associated with and/or representing tasks in the clinical protocol. In each processing state, clinical information may be collected, procedures may be performed, and/or decisions may be made based on collected information, for example.

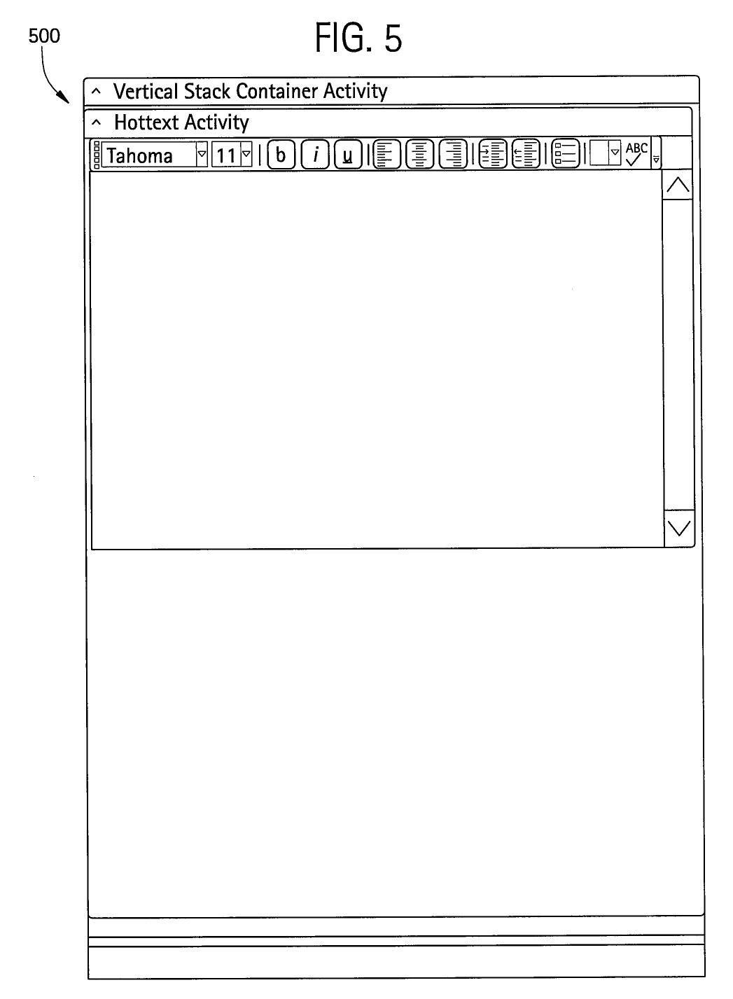

FIG. 5 illustrates an enlarged view of the form component 500 according to an embodiment of the present invention. The form component 500 is adapted allow a user to display and/or build the screens that are generated based on the workflow 410 for activities that provide output to a user and/or receive input from a user.

Referring now to FIGS. 1 and 3-5, in operation, a user, such as a clinician or other healthcare provider, may utilize the user interface 100 to design a workflow for a clinical protocol. The design of a workflow may include building a workflow from scratch or modifying an existing workflow, for example. The clinical protocol is visually represented by a workflow such as the workflow 410 illustrated in FIG. 4, discussed above. As the user designs the workflow, corresponding screens or forms are generated based on the workflow. These screens or forms are presented in the form component 500 of the user interface 100. The user may then modify the screens or forms using the form component 500.

As mentioned above, the workflow 410 represents a clinical workflow having one or more tasks. The workflow 410 includes one or more states, each state associated with and/or representing tasks in the clinical protocol. The workflow 410 may be designed and/or presented as a sequential flowchart for a clinical protocol that remains familiar to the clinician. Internally, however, the workflow 410 includes a state machine. The user interface 100 is adapted to generate the state machine for the workflow. The state machine is generated based on the clinical protocol. Generation of the state machine includes converting a sequential model of the clinical protocol into one or more states. Each state is associated with a task in the clinical protocol. Transitions are provided between states analogous to the transitions in the sequential clinical protocol. In addition, at least one state in the state machine includes a transition to a non-sequential state. That is, in the generated state machine, one or more transitions not present in the sequential clinical protocol. In certain embodiments, the state machine is a fully-connected state machine. Thus, while the clinical protocol may provide for limited or sequential transitions between states, the internal state machine of the workflow 410 is fully-connected, allowing transitions from one state to any other state. This allows the clinician to select any state in the workflow for current execution, skipping, or reordering steps as desired. In certain embodiments, the internal state machine for the workflow 410 is not fully-connected. For example, the state machine may include only transitions allowed between particular states. As another example, minimally, the internal state machine may include a single additional transition not included the express representation of the workflow 410. As another example, portions of states in the workflow 410 may be partitioned such that those states must be completed prior to proceeding to another set of states. Within the workflow 410, these partitioned states may be defined sequentially, but the internal state diagram may permit transitions between every state within a particular partition.

In certain embodiments, the sequential path of the clinical protocol is a recommended path through the workflow 410. In certain embodiments, the recommend path through the workflow 410 may be customized. For example, the recommended path may be customized based on the particular user. As another example, the recommended path may be customized based on a user group, such as ED nurses or clinicians. As another example, the recommended path may be customized based on department, hospital and/or, facility. As another example, the recommended path may be customized for an enterprise as a whole to promote standardization across the institution. In certain embodiments, a workflow 410 includes a best-practice path through the workflow 410.

Once a clinical protocol has been designed, it may be utilized in a clinical environment such as an Emergency Department, ICU, or ambulatory clinic, for example.

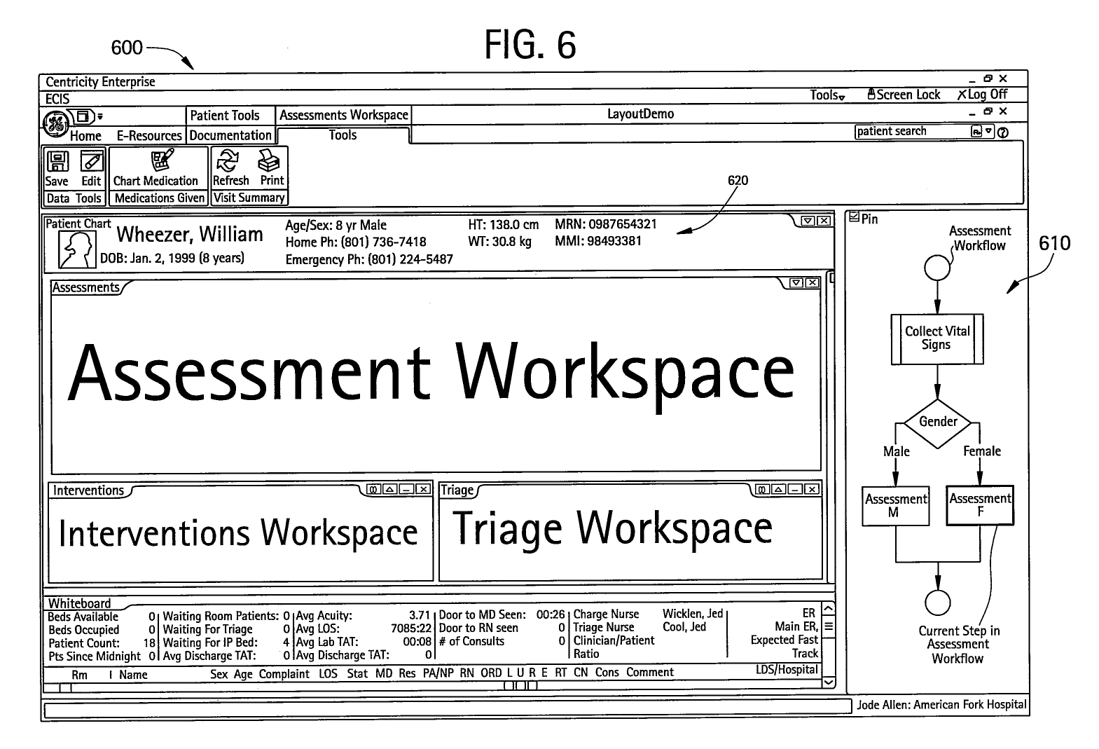

FIG. 6 illustrates a user interface 600 for a clinical workflow system according to an embodiment of the present invention. More particularly, the user interface 600 illustrated in FIG. 6 is for the execution of a workflow representing a clinical protocol. The user interface 600 includes a workflow visualization component 610 and a form workspace 620. The workflow visualization component 610 may be similar to the workflow visualization component 400, described above, for example.

In operation, a user, such as a clinician or other healthcare provider, may utilize the user interface 600 to execute a workflow representing a clinical protocol. The clinical protocol may have been designed at least in part using the user interface 100, described above, for example. The workflow may be displayed by the workflow visualization component 610. The visualization of the workflow 410 may be provided to a user such as a healthcare provider, for example. The user may review and/or input data for the workflow using the form workspace 620.

As in the user interface 100, described above, the clinical protocol being executed by the user interface 600 is visually represented by a workflow. The workflow visualization component 610 is adapted to provide the visual representation of a workflow. The workflow may be similar to the workflow 410, described above. The workflow 410 represents a clinical workflow having one or more tasks. The workflow 410 includes one or more states, each state associated with and/or representing tasks in the clinical protocol. In each processing state, clinical information may be collected, procedures may be performed, and/or decisions may be made based on collected information, for example.

In certain embodiments, the user interface 600 is part of the same application as the user interface 100. In certain embodiments, the workflow visualization component 610 is the same component as the workflow visualization component 400, discussed above. In certain embodiments, the workflow parts are the same between 100 and 600. Thus, the visualization of the clinical protocol may remain visible during both the construction and execution of the clinical protocol.

In certain embodiments, the user interface 600 is adapted to allow a user to select a current state from the one or more states of the workflow for current execution. In certain embodiments, a newly selected current state is non-sequential with a previously selected current state. That is, a user may select states out of the sequential order of the clinical protocol represented by the workflow. Thus, a user may skip states in the workflow.

The form workspace component 620 is adapted to provide output to a user and/or receive input from a user. The form workspace component 620 may display one or more forms associated with the current state in the clinical protocol. A workspace may be a metaphor for a collection of forms participating in the same workflow. Examples might be a form to collect preliminary forms and observations, a form to display the results of a clinical decision support system inference, and forms to collect follow-up information suggested by the Clinical Decision Support System (CDSS) inference. The forms may be forms built using the form component 500, described above, for example.

In certain embodiments, the workflow visualization component 610 is adapted to indicate the current state of the workflow. For example, the current state of the workflow may be shown in a different color or with a border.

In certain embodiments, the workflow visualization component 610 is adapted to indicate a completed state of the workflow. The completed state may be identified in a manner similar to the current state, discussed above, for example. For example, completed states may be shown in different colors or with a particular border.

In certain embodiments, an indication may be given of, for example, normal results, abnormal results, and/or critical results. For example, the indication may be graphical, such as an icon on a displayed form. The user may select the indicator to obtain more information, for example. For example, the user may click on an icon to see details as to why a result was abnormal. The user may be able to view only certain types of results, for example. For example, the user may view only critical results. Similarly, actions or tasks having varying degrees of importance may be represented using different indications. Actions or tasks having varying degrees of completion may also be represented using different indications, for example.

In certain embodiments, values entered in a form presented by the form workflow component 620 are exposed as attributes of the workflow activities. That is, the workflow may be updated and/or altered based on data entered into a form. This may allow direct calculations, decision support system calls, and/or workflow decisions to be made directly with the entered data, for example. For example, based on one or more values entered into a form, the user interface 600 may provide decision support to a user. As another example, in a workflow for a triage process, the gender of the patient may be selected as a step. Subsequent forms for various steps in the workflow may then reflect this gender selection. For example, in a triage form, information collected for a man is different than information collected for a woman; if sex male is entered by the user, the workflow would not display the portion of a form asking if the patient were pregnant.

In certain embodiments, the user interface 600 is adapted to provide context sensitive help. The context sensitive help may be associated with one or more states of the workflow, for example. The context sensitive help may provide information relevant to that step of the protocol, for example. In certain embodiments, links to relevant information for a particular protocol step are associated with the workflow state. For example, at a particular step in a clinical care plan, the author of the plan often provides help to the clinician to detail the care being provided in that step or to provide additional information to assist in performing the diagnosis. Such embodiments allow documentation of a clinical protocol to be combined with the definition of the protocol and thus be immediately available to the clinician as the tool is used. This may allow for reduced training costs for a customer in rolling out the application to new users, for example.

In certain embodiments, the user interface 600 supports the removal of steps from the workflow. For example, an inference from a CDSS may suggest a common treatment path is not applicable, for example due to a patient condition such as an allergy inferred by the CDSS. In certain embodiments, the user interface 600 supports the addition of new steps dynamically as the protocol is executed. For example, an inference from a CDSS may suggest an uncommon alternate diagnosis path; one that was not present in the original presentation of the clinical care plan but anticipated by the author of the plan.

In certain embodiments, the user interface 600 is adapted to provide a recommended path through the workflow. The sequential path of the clinical protocol may be used as a recommended path through the workflow, for example. In certain embodiments, the recommend path through the workflow may be customized. For example, the recommended path may be customized based on the particular user. As another example, the recommended path may be customized based on a user group, such as ED nurses or clinicians. As another example, the recommended path may be customized based on department, hospital and/or, facility. As another example, the recommended path may be customized for an enterprise as a whole to promote standardization across the institution. In certain embodiments, a workflow includes a best-practice path through the workflow.

In certain embodiments, the user interface 600 is adapted to allow a user to perform a what-if analysis. The workflow, represented internally as a state machine, as described above, may be analyzed to determine a more productive, efficient, and/or effective workflow for a particular clinical scenario. For example, a what-if analysis may be performed to determine an optimum care scenario for a particular situation. For example, a physician may suggest a particular drug be administered at a particular step and allow subsequent steps in the workflow, for example a CDSS call based on the drug, to be simulated without actually executing the step.

In certain embodiments, the what-if analysis may be used for teaching, presentation and/or research purposes. For example, the what-if analysis may be utilized to train interns or in discussions in group settings. An analysis may be performed on various paths that care can take and provide examples of ineffective versus effective care scenarios. In certain embodiments, the what-if analysis may be used to recommend a path through the workflow. For example, the what-if analysis may be heuristic and may generate a recommendation based on historical trends. For example, a teaching physician may suggest a particular drug be administered at a particular step, use historical data to provide common laboratory results after administering this drug, and allow subsequent steps in the workflow, for example a CDSS call based on the drug and the laboratory results, to be simulated without actually executing the step.

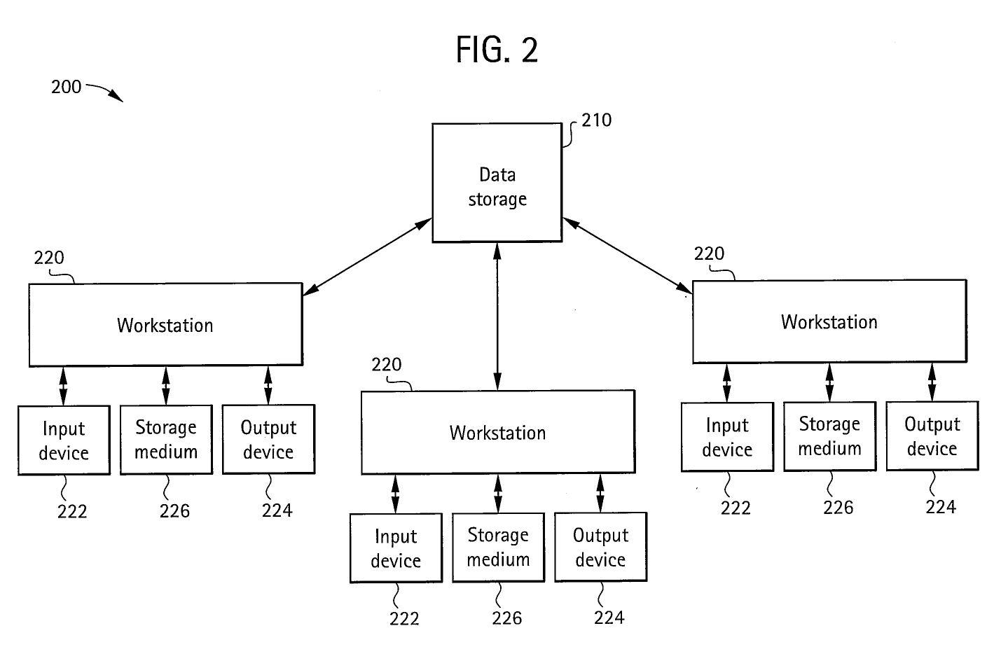

In certain embodiments, a user interface for clinical workflows, such as user interface 100 and/or user interface 600, described above, may be utilized with a system such as the system 200 illustrated in FIG. 2. FIG. 2 illustrates a system 200 for creating and/or executing clinical protocols according to an embodiment of the present invention. System 200 includes at least one data storage 210 and at least one workstation 220. While three workstations 220 are illustrated in system 200, a larger or smaller number of workstations 220 can be used in accordance with embodiments of the presently described technology. In addition, while one data storage 210 is illustrated in system 200, system 200 can include more than one data storage 210. For example, each of a plurality of entities (such as remote data storage facilities, hospitals or clinics) can each include one or more data stores 210 in communication with one or more workstations 220.

As illustrated in system 200, one or more workstations 220 can be in communication with at least one other workstation 220 and/or at least one data storage 210. Workstations 220 can be located in a single physical location or in a plurality of locations. Workstations 220 can be connected to and communicate via one or more networks.

Workstations 220 can be directly attached to one or more data stores 210 and/or communicate with data storage 210 via one or more networks. Each workstation 220 can be implemented using a specialized or general-purpose computer executing a computer program for carrying out the processes described herein. Workstations 220 can be personal computers or host attached terminals, for example. If workstations 220 are personal computers, the processing described herein can be shared by one or more data stores 210 and a workstation 220 by providing an applet to workstation 220, for example.

Workstations 220 include an input device 222, an output device 224 and a storage medium 226. For example, workstations 220 can include a mouse, stylus, microphone and/or keyboard as an input device. Workstations 220 can include a computer monitor, liquid crystal display (“LCD”) screen, printer and/or speaker as an output device.

Storage medium 226 of workstations 220 is a computer-readable memory. For example, storage medium 226 can include a computer hard drive, a compact disc (“CD”) drive, a USB thumb drive, or any other type of memory capable of storing one or more computer software applications. Storage medium 226 can be included in workstations 220 or physically remote from workstations 220. For example, storage medium 226 can be accessible by workstations 220 through a wired or wireless network connection.

Storage medium 226 includes a set of instructions for a computer. The set of instructions includes one or more routines capable of being run or performed by workstations 220. The set of instructions can be embodied in one or more software applications or in computer code. For example, the set of instructions may be for a user interface similar to the user interface 100 and/or the user interface 600, described above.

Data storage 210 can be implemented using a variety of devices for storing electronic information such as a file transfer protocol (“FTP”) server, for example. Data storage 210 includes electronic data. For example, data storage 210 may store healthcare information. As another example, data storage 210 may store clinical protocols for use with user interface 100 and/or user interface 600. Data storage 210 may include and/or be in communication with one or more clinical information systems, for example.

Communication between workstations 220, workstations 220 and data storage 210, and/or a plurality of data stores 210 can be via any one or more types of known networks including a local area network (“LAN”), a wide area network (“WAN”), an intranet, or a global network (for example, Internet). Any two of workstations 220 and data stores 210 can be coupled to one another through multiple networks (for example, intranet and Internet) so that not all components of system 200 are required to be coupled to one another through the same network.

Any workstations 220 and/or data stores 210 can be connected to a network or one another in a wired or wireless fashion. In an example embodiment, workstations 220 and data store 210 communicate via the Internet and each workstation 220 executes a user interface application to directly connect to data store 210. In another embodiment, workstation 220 can execute a web browser to contact data store 210. Alternatively, workstation 220 can be implemented using a device programmed primarily for accessing data store 210.

Data storage 210 can be implemented using a server operating in response to a computer program stored in a storage medium accessible by the server. Data storage 210 can operate as a network server (often referred to as a web server) to communicate with workstations 220. Data storage 210 can handle sending and receiving information to and from workstations 220 and can perform associated tasks. Data storage 210 can also include a firewall to prevent unauthorized access and enforce any limitations on authorized access. For instance, an administrator can have access to the entire system and have authority to modify portions of system 200 and a staff member can only have access to view a subset of the data stored at data store 210. In an example embodiment, the administrator has the ability to add new users, delete users and edit user privileges. The firewall can be implemented using conventional hardware and/or software.

Data store 210 can also operate as an application server. Data store 210 can execute one or more application programs to provide access to the data repository located on data store 210. Processing can be shared by data store 210 and workstations 220 by providing an application (for example, a java applet). Alternatively, data store 210 can include a stand-alone software application for performing a portion of the processing described herein. It is to be understood that separate servers may be used to implement the network server functions and the application server functions. Alternatively, the network server, firewall and the application server can be implemented by a single server executing computer programs to perform the requisite functions.

The storage device located at data storage 210 can be implemented using a variety of devices for storing electronic information such as an FTP server. It is understood that the storage device can be implemented using memory contained in data store 210 or it may be a separate physical device. The storage device can include a variety of information including a data warehouse containing data such as patient medical data, for example. As another example, the storage device may include a workflow 410 for a clinical protocol.

Data storage 210 can also operate as a database server and coordinate access to application data including data stored on the storage device. Data storage 210 can be physically stored as a single database with access restricted based on user characteristics or it can be physically stored in a variety of databases.

In an embodiment, data store 210 stores one or more workflows 410 corresponding to one or more clinical protocols.

In operation, a user employs a workstation 220 to display, on an output device 224, a user interface for a clinical workflow system such as user interface 100 and/or user interface 600, described above. As described above, workstation 220 includes computer-readable storage medium 226 that itself comprises a set of instructions for workstation 220. The set of instructions can be embodied in one or more computer software applications or computer code. This set of instructions is used by workstation 220 to create and/or execute a workflow representing a clinical protocol. Thus, at least one technical effect of the set of instructions is to aggregate and provide data and functionality from one or more clinical systems so as to enable one or more users to create and execute a workflow representing a clinical protocol, for example.

The set of instructions includes one or more software routines. In certain embodiments, the set of instructions includes a user interface routine for a workflow building application. The user interface routine allows a user to build a workflow for a clinical protocol that is internally represented as a state machine. In certain embodiments, the set of instructions includes a user interface routine for executing a workflow representing a clinical protocol. The workflow may be the workflow built using the user interface for the workflow building application. In certain embodiments, the workflow building application user interface and the workflow execution user interface are part of the same application.

One or more embodiments of the presently described invention provide several advantages. In certain embodiments, the user interface and presentation of a tool is coupled with a workflow engine by representing user interface elements as workflow activities. In certain embodiments, the familiar sequential workflow is transparently converted to a state machine to allow user flexibility in executing the workflow. In certain embodiments a run-time view of the protocol is presented as a clinician uses it showing them completed activities, the current activity, upcoming activities, and documentation of each activity as part of a single tool.

Certain embodiments provide improved productivity by coupling the design and presentation of a clinical protocol with the presentation of the forms and panels used to collect and analyze information relating to the protocol. Certain embodiments provide improved productivity and quality for a clinical user by providing a mechanism to described, document, and execute best-practice protocols through a standard and extensible tool. Certain embodiments allow for reduced training costs for the customer in rolling out the application to new users because documentation of a clinical protocol is combined with the definition of the protocol and immediate available to the clinician as the tool is used. Certain embodiments allow for performing what-if analyses to determine improved and/or optimal care scenarios for a particular situation and/or for teaching, presentation, and/or research purposes.

The components, elements, and/or functionality of the interface(s) and system(s) described above may be implemented alone or in combination in various forms in hardware, firmware, and/or as a set of instructions in software, for example. Certain embodiments may be provided as a set of instructions residing on a computer-readable medium, such as a memory or hard disk, for execution on a general purpose computer or other processing device, such as, for example, a PACS workstation or one or more dedicated processors.

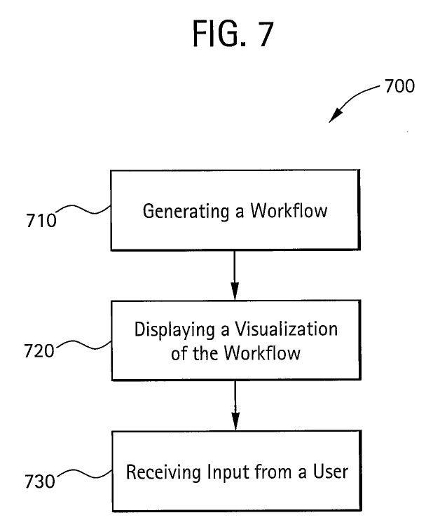

FIG. 7 illustrates a flow diagram for a method 700 for performing a clinical protocol according to an embodiment of the present invention. The method 700 includes the following steps, which will be described below in more detail. At step 710, a workflow is generated. At step 720, a visualization of the workflow is displayed. At step 730, input is received from a user. The method 700 is described with reference to elements of systems described above, but it should be understood that other implementations are possible.

At step 710, a workflow is generated. The workflow may be similar to the workflow 410, discussed above, for example. The workflow may be generated by a user interface. For example, the workflow may be generated by a user interface similar to the user interface 100 and/or the user interface 600, discussed above.

The workflow represents a clinical workflow having one or more tasks. The workflow includes one or more states, each state associated with and/or representing tasks in the clinical protocol. The workflow may be designed and/or presented as a sequential flowchart for a clinical protocol that remains familiar to the clinician. Internally, however, the workflow includes a state machine. The state machine of the workflow is generated based on the clinical protocol. Generation of the state machine includes converting a sequential model of the clinical protocol into one or more states. Each state is associated with a task in the clinical protocol. Transitions are provided between states analogous to the transitions in the sequential clinical protocol. In addition, at least one state in the state machine includes a transition to a non-sequential state. That is, in the generated state machine, one or more transitions not present in the sequential clinical protocol. In certain embodiments, the state machine is a fully-connected state machine. Thus, while the clinical protocol may provide for limited or sequential transitions between states, the internal state machine of the workflow is fully-connected, allowing transitions from one state to any other state. This allows the clinician to select any state in the workflow for current execution, skipping, or reordering steps as desired. In certain embodiments, the internal state machine for the workflow is not fully-connected. For example, the state machine may include only transitions allowed between particular states. As another example, minimally, the internal state machine may include a single additional transition not included the express representation of the workflow. As another example, portions of states in the workflow may be partitioned such that those states must be completed prior to proceeding to another set of states. Within the workflow, these partitioned states may be defined sequentially, but the internal state diagram may permit transitions between every state within a particular partition.

At step 720, a visualization of the workflow is displayed. The visualization of the workflow may displayed by a workflow visualization component. The workflow visualization component may be similar to the workflow visualization component 400 and/or the workflow visualization component 610, discussed above, for example.

In certain embodiments, the workflow visualization component is part of the same user interface used to build the workflow as the user interface used to execute the workflow. Thus, the visualization of the clinical protocol may remain visible during both the construction and execution of the clinical protocol.

In certain embodiments, the visualization of the workflow indicates the current state of the workflow. For example, the current state of the workflow may be shown in a different color or with a border.

In certain embodiments, the visualization of the workflow indicates a completed state of the workflow. The completed state may be identified in a manner similar to the current state, discussed above, for example. For example, completed states may be shown in different colors or with a particular border.

In certain embodiments, visualization of the workflow indicates one or more of normal results, abnormal results, and/or critical results. For example, the indication may be graphical, such as an icon on a displayed form. The user may select the indicator to obtain more information, for example. For example, the user may click on an icon to see details as to why a result was abnormal. The user may be able to view only certain types of results, for example. For example, the user may view only critical results. Similarly, actions or tasks having varying degrees of importance may be represented using different indications. Actions or tasks having varying degrees of completion may also be represented using different indications, for example.

At step 730, input is received from a user. The input may be received through a user interface. The user interface may be similar to the user interface 100 and/or the user interface 600, discussed above, for example

The input from the user may be provided through a form associated with a state of the workflow, for example. For example, a form workspace component, such as form workspace component 620, discussed above, may display one or more forms associated with the current state in the clinical protocol. The forms may be forms built using a form component similar to the form component 500, described above, for example.

In certain embodiments, values entered in a form are exposed as attributes of the workflow activities. That is, the workflow may be updated and/or altered based on data entered into a form. This may allow direct calculations, decision support system calls, and/or workflow decisions to be made directly with the entered data, for example. For example, based on one or more values entered into a form, the user interface may provide decision support to a user. As another example, in a workflow for a triage process, the gender of the patient may be selected as a step. Subsequent forms for various steps in the workflow may then reflect this gender selection.

In certain embodiments, the workflow is built using the same user interface as the user interface used to execute the workflow. The user interface to build the workflow may be similar to the user interface 100, discussed above, for example. The user interface to execute the workflow may be similar to the user interface 600, discussed above, for example. A health care provider may use the user interface to design the workflow, for example.

The design of a workflow may include building a workflow from scratch or modifying an existing workflow, for example. As the user designs the workflow, corresponding screens or forms may be generated based on the workflow. Building the workflow may include allowing a user to display and/or build the screens that are generated based on the workflow for activities that provide output to a user and/or receive input from a user. The forms may be built by a form component similar to the form component 500, discussed above, for example. The user may then modify the screens or forms using the form component.

One or more of the steps of the method 700 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Several embodiments are described above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any machine-readable media for accomplishing its operations. As noted above, the embodiments of the present invention may be implemented using an existing computer processor, or by a special purpose computer processor incorporated for this or another purpose or by a hardwired system.

As noted above, certain embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Certain embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Certain embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

Those skilled in the art will appreciate that the embodiments disclosed herein may be applied to the formation of any clinical system. Certain features of the embodiments of the claimed subject matter have been illustrated as described herein; however, many modifications, substitutions, changes and equivalents will now occur to those skilled in the art. Additionally, while several functional blocks and relations between them have been described in detail, it is contemplated by those of skill in the art that several of the operations may be performed without the use of the others, or additional functions or relationships between functions may be established and still be in accordance with the claimed subject matter. It is, therefore, to be understood that the appended claims are intended to cover all such modifications and changes as fall within the true spirit of the embodiments of the claimed subject matter.

1. A clinical workflow system including:
a user interface adapted to present a visualization of a workflow to a user, wherein the workflow represents a clinical protocol including a plurality of tasks, wherein the user interface is adapted to generate a state machine for the workflow based on the clinical protocol by converting a sequential model of the clinical protocol into a plurality of states, wherein each state is associated with a task in the clinical protocol, wherein at least one state in the state machine is connected with a non-sequential state.

2. The system of claim 1, wherein the user interface is adapted to allow the user to select a current state from the plurality of states of the workflow for current execution.

3. The system of claim 2, wherein the current state selected is non-sequential.

4. The system of claim 2, wherein the user interface is adapted to indicate the currently selected state.

5. The system of claim 2, further including a form for data entry associated with the current state.

6. The system of claim 1, wherein the states of the state machine are fully connected.

7. The system of claim 1, wherein the user interface is adapted to allow the user to skip a state in the workflow.

8. The system of claim 1, wherein the workflow includes a partitioning of states in the plurality of states.

9. The system of claim 1, wherein the user interface is adapted to allow the user to perform a what-if analysis of the workflow.

10. The system of claim 1, wherein the user interface is adapted to provide context sensitive help for one or more of the plurality of states.

11. The system of claim 1, wherein the user interface is adapted to indicate a completed state.

12. The system of claim 1, wherein the user interface is adapted to provide decision support based on data entered by the user in one or more of the plurality of states.

13. The system of claim 1, wherein the user interface is adapted to provide a recommended path through the workflow.

14. The system of claim 13, wherein the recommended path is customized for at least one of a particular user, a group of users, a department, and a healthcare facility.

15. The system of claim 1, wherein the user interface is further adapted to allow the user to build the workflow.

16. The system of claim 15, wherein building the workflow includes designing at least one form associated with a state of the workflow.

17. A method for performing a clinical protocol, the method including:
generating a workflow including a state machine, wherein the workflow represents a clinical protocol including a plurality of tasks, wherein the state machine is generated based on the clinical protocol by converting a sequential model of the clinical protocol into a plurality of states, wherein each state is associated with a task in the clinical protocol, wherein at least one state in the state machine is connected with a non-sequential state;
displaying a visualization of the workflow to a user with a user interface; and
receiving input from the user relating to a current state of the workflow.

18. The method of claim 17, wherein the states of the state machine are fully connected.

19. The method of claim 17, further including building the workflow with the user interface.

20. A computer-readable medium including a set of instructions for execution on a computer, the set of instructions including:
a workflow generation routine configured to generate a workflow including a state machine, wherein the workflow represents a clinical protocol including a plurality of tasks, wherein the state machine is generated based on the clinical protocol by converting a sequential model of the clinical protocol into a plurality of states, wherein each state is associated with a task in the clinical protocol, wherein at least one state in the state machine is connected with a non-sequential state;
a workflow display routine configure to display a visualization of the workflow to a user; and
an input routine configure to receive input from the user relating to a current state of the workflow.
